(19) United States
(12) Patent Application Publication
(10) Pub. No.: US 2026/0325403 A1
(43) Pub. Date: Oct. 22, 2026

(54) TRIGGER POINT AND MUSCLE RELEASE TOOL

(71) Applicant: Keely Taylor, IdyllwiId, CA (US)

(72) Inventor: Keely Taylor, IdyllwiId, CA (US)

(21) Appl. No.: 19/566,961

(22) Filed: Mar. 13, 2026

Related U.S. Application Data
(60) Provisional application No. 63/771,618, filed on Mar. 13, 2025.

(51) Int. Cl. A61H 39/04

(52) U.S. Cl. CPC A61H 39/04; A61H 2201/0153; A61H 2201/1695

(57) ABSTRACT

A tool for treatment of physical injuries, conditions or for general therapeutic use includes a first elongate member and a second elongate member that extend away from a central structure. Each elongate member terminates at a distal tip. The tool enables a user to apply pressure at a trigger point or on a muscle. Pressure can be controlled by the force or weight applied by the user. The tool can be used to relieve muscle tension. Each tip defines the size and shape of an area to receive pressure. Methods of using the tool include applying a spoon-shaped tip to release the iliopsoas muscle group while a person is in a supine position, and applying a knob-shaped tip to locate and release trigger points in a broad range of muscles and muscle groups.

### PRIORITY CLAIM

This application claims priority to and the benefit of provisional patent application No. 63/771,618 filed in the United States Patent Office on Mar. 13, 2025, entitled “Trigger Point And Muscle Release Tool,” and the entire content of this application is incorporated herein by reference as if fully set forth below in its entirety and for all applicable purposes.

### TECHNICAL FIELD

The present application relates to therapeutic equipment, and more particularly to a tool that can apply targeted pressure at multiple locations.

### BACKGROUND

Generally, tools that can be used in myofascial release therapy may be unable to access all of the groups of muscles that are being concurrently treated. Moreover, conventional tools can be difficult to use, particularly when other injuries prevent manipulation, positioning and application of sufficient or sustained pressure during self-treatment at home and elsewhere.

### SUMMARY

Certain aspects of the disclosure relate to tools, systems, apparatus, methods and techniques that can be used in physical therapy. In one example, a tool configured in accordance with certain aspects of this disclosure may be used to slowly apply and sustain pressure to muscles in order to stretch tissues in a manner that can lead to reduction in muscle tightness.

In various aspects of the disclosure, a tool for applying pressure to a muscle includes a central structure configured to fit a hand of a user, a first elongate member extending away from the central structure and terminating at a first tip, and a second elongate member extending away from the central structure and terminating at a second tip.

In various aspects of the disclosure, a method of using a trigger point and muscle release tool includes gripping a central structure of the tool, positioning a first tip in contact with a target location on a muscle of a person, applying pressure at the target location through the first tip and maintaining the applied pressure for a predetermined duration. The central structure may be configured to fit a hand of a user. The first tip may be located at a terminal end of a first elongate member that extends away from the central structure. The tool may include a second elongate member that extends away from the central structure and terminates at a second tip that has a form that differs from the form of the first tip.

In one example, the first tip has a spherical surface. In another example, the first tip includes a hemispherical structure. In another example, the first tip has a frustoconical portion. In some instances, a surface of the first tip includes a portion of a polyhedron.

In some implementations, at least one tip has a flattened circular shape.

In certain implementations, the tool has a spoon-shaped tip. The spoon-shaped tip may be configured to release a muscle group upon contact. The spoon-shaped tip may be configured to release an iliopsoas muscle group of a supine person. The spoon-shaped tip may be configured to release a psoas muscle of a supine person.

In some examples, the first elongate member extends away from the central structure along a first line and the second elongate member extends away from the central structure along a second line and wherein an obtuse angle is provided between the first line and the second line.

In some examples, the first elongate member extends away from the central structure along a first line and the second elongate member extends away from the central structure along a second line and wherein an acute angle is provided between the first line and the second line.

In some implementations, the central structure has a size and shape configured to be gripped with both hands of a user simultaneously.

In some implementations, the first tip is configured to locate and apply pressure to a trigger point on a muscle.

### BRIEF DESCRIPTION OF THE DRAWINGS

FIG. 1 illustrates an example of a tool manufactured in accordance with certain aspects of this disclosure.

FIG. 2 illustrates a first configuration of the tool shown in FIG. 1 when gripped by a user.

FIG. 3 illustrates additional configurations of the tool shown in FIG. 1 when gripped by a user.

FIG. 4 is a flowchart illustrating a method of using a trigger point and muscle release tool according to certain aspects of this disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Certain aspects of this disclosure relate to a tool that may be used in physical therapy. In one example, a tool configured in accordance with certain aspects of this disclosure may be used during myofascial release therapy. The tool may be used to slowly apply and sustain pressure to muscles in order to stretch tissues in a manner that can lead to reduction in muscle tightness. The pressure applied to muscles may reduce musculoskeletal pain and improve movement. The pain need not be directly associated with the point at which pressure is applied. For example, tightness may form at a trigger point in a muscle, and such tightness need not cause pain perceived at the trigger point. A trigger point can cause referred pain or reflective pain in areas that are distant from the trigger point. It may be desirable or necessary to release tightness at a trigger point and at points distant from the trigger point in order to treat musculoskeletal conditions.

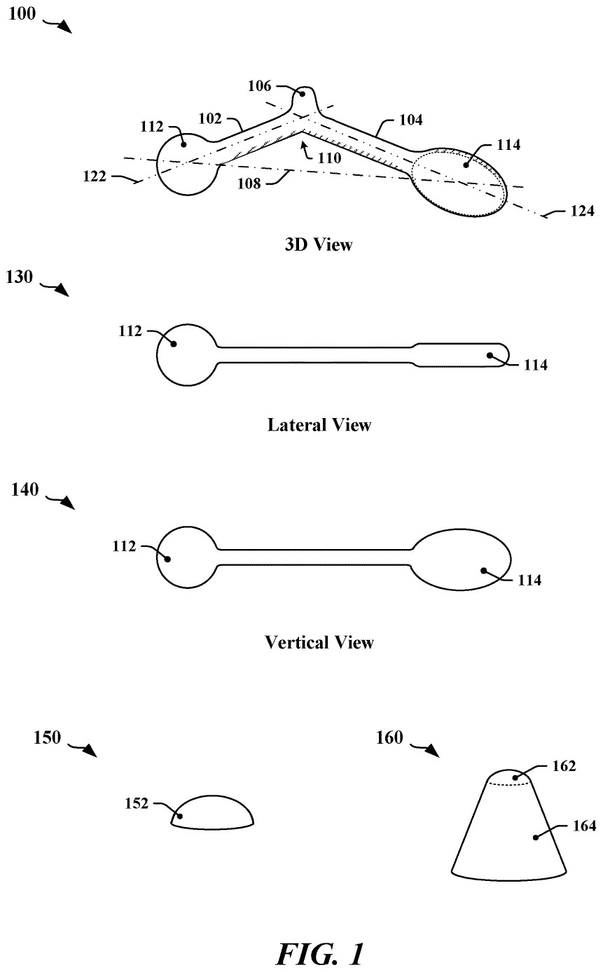

Certain aspects of the disclosure relate to a device that can be used for treatment of physical injuries or conditions and/or for general therapeutic use. FIG. 1 shows different views 100, 130, 140 of a device that may be configured as a handheld tool or device that enables a user to apply pressure at a trigger point or on a muscle in accordance with certain aspects of this disclosure. Pressure can be controlled by the force or weight applied by the user. In one example, the device may be used to relieve muscle tension. In certain implementations, the device includes two elongate members 102, 104, each elongate member 102, 104 having a tip 112, 114 that defines the size and shape of an area to receive pressure. In the illustrated example, a first tip 112 has a substantially spherical structure and the second tip 114 is spoon-shaped. In other examples, the first tip 112 may include a hemispherical structure 150, with a domed portion 152 extending beyond a plane of the corresponding elongate member 102. In other examples, the first tip 112 may include a frustoconical structure 160, whereby a domed portion 162 of the first tip 112 is provided on the end of a partial cone 164 that extends beyond a plane of the corresponding elongate member 102.

In some implementations, the user holds, grips and/or manipulates the device using a handle structure 106 that extends from a point 110 on the device located between the tips 112, 114. Typically, the handle structure 106 is in a central location of the device and may be referred to herein as a central structure of the tool. In the illustrated example, the handle structure 106 is provided closer to one of the two tips 112, 114. In other examples, the handle structure 106 extends along a line that substantially bisects a line 108 drawn between the tips 112, 114. In certain implementations, tips 112, 114 extend along lines 122, 124 that intersect at the handle structure 106. In one example, the angle between the intersecting lines 122, 124 may be selected to facilitate a desired distribution of pressure applied by the user.

In one example, a method for using the device includes placing a first tip 112 on a trigger point. The second tip 114 may be placed on a muscle. In another example, second tip 114 may be placed on a trigger point and the first tip 112 may be placed on a muscle. Pressure may be applied when the tips 112, 114 are in position. The pressure results from the force or weight applied to the device by the user. The distribution of pressure between the tips 112, 114 may be determined by the angle at which the user applies force to the device. The location at which the tips 112, 114 contact muscle or trigger points, which may be collectively referred to herein as “pressure points”, may be adjusted or manipulated by the user in the process of relieving muscle tension. According to one aspect, the device may be used for self-treatment.

A device configured in accordance with certain aspects of this disclosure may be manufactured using some combination of wood, laminate, polymer, metal, carbon fiber, composite, fiberglass, ceramic, foam or another suitable material. Polymers may include polyethylene, Acrylonitrile Butadiene Styrene (ABS) or another type of impact resistant plastic, polyethylene terephthalate glycol (PETG), among others. In some implementations, the device or portions of the device may be molded or 3D-printed using a resin (e.g., a polyurethane resin), ceramic or polymer. In some examples, the device may be manufactured from some combination of metal and polymer parts. In some examples, the device may be manufactured using parts that are multilayered and may include some combination of metal and polymer layers. Covers or caps may be used to configure the surface of the tips 112, 114. In some implementations, one or both of the tips 112, 114 may be coated with a material that provides a desired level of friction. In one example, a non-slip coating may be desirable. In other examples, a low-friction coating may be applied. In various examples, the surface of the tips 112, 114 may be capped or coated with non-woven or woven web materials or with materials manufactured from polytetrafluoroethylene (PTFE), vinyl, nitrile, latex, certain other polymers or similar materials.

In certain implementations, a device configured in accordance with certain aspects of this disclosure may be manufactured with removable and/or replaceable tips 112, 114. In one example, the tips 112, 114 may be independently manufactured and fastened using screws, threads, latches, or some other fastening device. In certain implementations, a device configured in accordance with certain aspects of this disclosure may be manufactured with a removable and/or replaceable handle structure 106. The shape, size or other aspects of the handle structure 106, whether removable or not, may be configured to desired or specified application requirements.

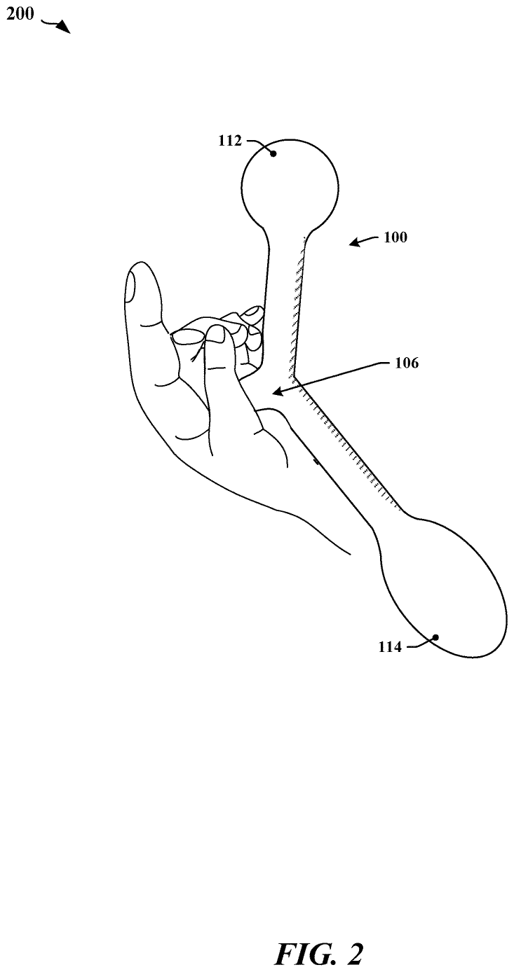

FIG. 2 illustrates a first configuration 200 of the tool illustrated in FIG. 1. In this configuration 200, the handle structure 106 is gripped between the thumb and the palm of a user's hand. The handle structure 106 may have a shape, size and/or thickness that facilitates cradling of the handle structure 106 in the palm, thereby providing stability and/or providing a base for leverage as force is applied to the tool illustrated in FIG. 1.

In some instances, the handle structure 106 may be gripped between the thumb and one or more fingers of the user's hand. In these instances, the use of thumbs and fingers may provide additional dexterity that provides improved control over movement of the tool illustrated in FIG. 1.

The spoon-shaped tip 114 may be shaped and/or sized to target a specific type of pressure point. In one example, a spoon-shaped tip 114 may be configured to promote release of a muscle group upon contact, including when pressure is applied through the spoon-shaped tip 114. For example, the spoon-shaped tip 114 can be used to release the iliopsoas muscle group. The iliopsoas muscle group is a flexor associated with the human hip and includes iliacus and psoas muscles. The spoon-shaped tip 114 can be used to release the psoas muscle, for example.

A person receiving treatment may be located in a supine or other face-up position when applying a device configured in accordance with certain aspects of this disclosure. The tool may be used while the person receiving treatment is lying face-up on a horizontal surface. The person receiving treatment may be positioned with the back on a horizontal surface and feet on the floor, typically with knees bent. In some instances, the floor may provide the horizontal surface. In some instances, the horizontal surface is in a parallel planar alignment with the floor. In some instances, the psoas muscle of a person receiving treatment may be released by the spoon-shaped tip 114, while the person receiving treatment is located in a seated position or reclined position.

Both tips 112, 114 of a device configured in accordance with certain aspects of this disclosure may be used as a trigger point release tool. The structure, size and orientation of the tips 112, 114 can be configured to optimize use in certain anatomical areas. As discussed herein, a spoon-shaped tip 114 is well-suited for use with the iliopsoas muscle group, but can be used for other muscles and muscle groups.

In another example, a tip 112 having a spherical, hemispherical, frustoconical structure, or a structure having another such shape, can be used on a broad range of muscles and muscle groups. For example, the illustrated tip 112 may be used to access muscles of the face and head (e.g., the masseter and/or temporalis muscles), muscles of the upper shoulder (e.g., the levator scapulae and/or upper trapezius muscles), muscles of the anterior shoulder (e.g., the anterior deltoid and/or biceps head), muscles of the forearm (e.g., the brachioradialis muscle and/or arm flexors and extensors), muscles of the hand, the thenar eminence, the pectoralis group, lower leg muscles (e.g., gastrocnemius, soleus and/or tibialis anterior muscles), the quadriceps muscle group, and muscles in the feet.

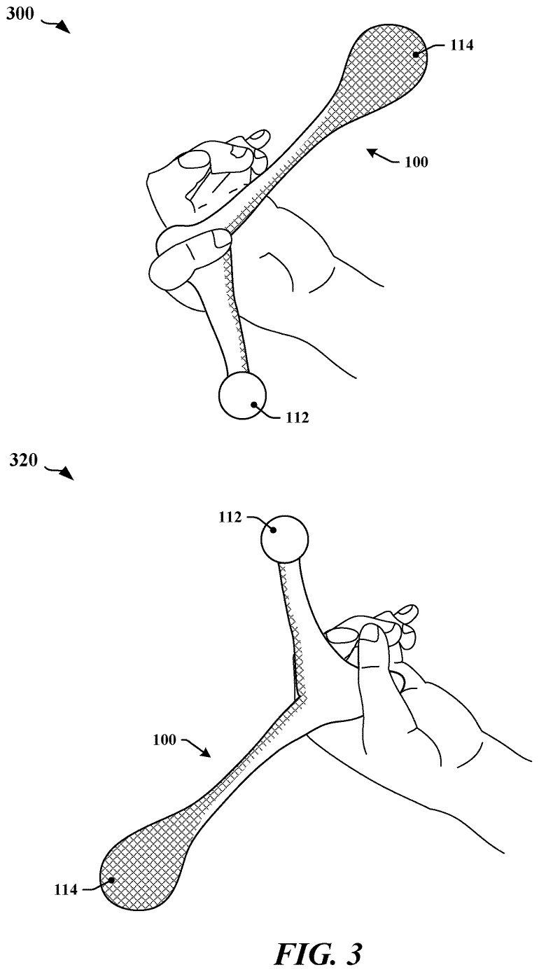

FIG. 3 shows additional configurations 300, 320 of the tool illustrated in FIG. 1. These configurations 300, 320 may be used to improve reach or improve accessibility of zones to be targeted by the tool illustrated in FIG. 1.

A tool configured in accordance with certain aspects of this disclosure may be used for applying pressure to a muscle. In certain implementations, the tool has a central structure configured to fit a hand of a user, a first elongate member extending away from the central structure and terminating at a first tip, and a second elongate member extending away from the central structure and terminating at a second tip. In some implementations, the tool has a central structure of a size and shape configured to be gripped with both hands of a user simultaneously.

In one example, the first tip has a substantially spherical surface. In one example, the first tip has a spherical surface. In one example, the first tip includes a hemispherical structure. In one example, the first tip has a frustoconical portion. In one example, a surface of the first tip includes a portion of a polyhedron. In one example, at least one tip has a flattened circular shape.

In certain implementations, the tool comprises a spoon-shaped tip. The spoon-shaped tip may be configured to release a muscle group upon contact. The spoon-shaped tip may be configured to release an iliopsoas muscle group of a supine person. The spoon-shaped tip may be configured to release a psoas muscle of a supine person.

In certain implementations, the first elongate member extends away from the central structure along a first line and the second elongate member extends away from the central structure along a second line. An obtuse angle may be provided between the first line and the second line.

In certain implementations, the first elongate member extends away from the central structure along a first line and the second elongate member extends away from the central structure along a second line and wherein an acute angle is provided between the first line and the second line.

In one example, the device may be used to release the iliopsoas muscle group. To perform this method, a person receiving treatment finds a comfortable position lying on their back on a horizontal surface with knees bent and feet on the floor. The spoon-shaped tip 114 of the second elongate member 104 is placed into the iliopsoas or anterior hip area, just inside the hip bone in the soft area of the lower abdomen. The user moves the tool slowly until a tender or tight spot is located. Both hands are placed on the upper portion or handle structure 106 of the tool, and a steady, firm pressure is applied into the muscle. The pressure should feel deep but manageable. The person receiving treatment takes slow breaths and allows the body to relax. Pressure is held on the trigger point for 30 to 60 seconds. While maintaining pressure, the person slowly straightens the leg and then bends it again. This movement is repeated three to five times. A deeper stretch or sensitivity during the movement is normal. The pressure is then slowly released. The same method may be repeated on the opposite side.

In another example, the device may be used to release a general trigger point on a broad range of muscles and muscle groups. To perform this method, the knob-shaped tip 112 of the first elongate member 102 is used. The user locates a trigger point by placing the knob-shaped tip 112 on the target muscle and slowly moving it around until a tender or tight spot is found. Once the trigger point is located, firm, steady pressure is applied with the knob-shaped tip 112. The pressure should feel deep but manageable. The person receiving treatment takes slow, relaxed breaths while pressure is maintained for some duration of time. In one example, pressure may be maintained for 30 to 60 seconds, or until the muscle begins to soften. The pressure is then slowly released. If additional trigger points are present, the tool may be repositioned and the method repeated at each subsequent trigger point.

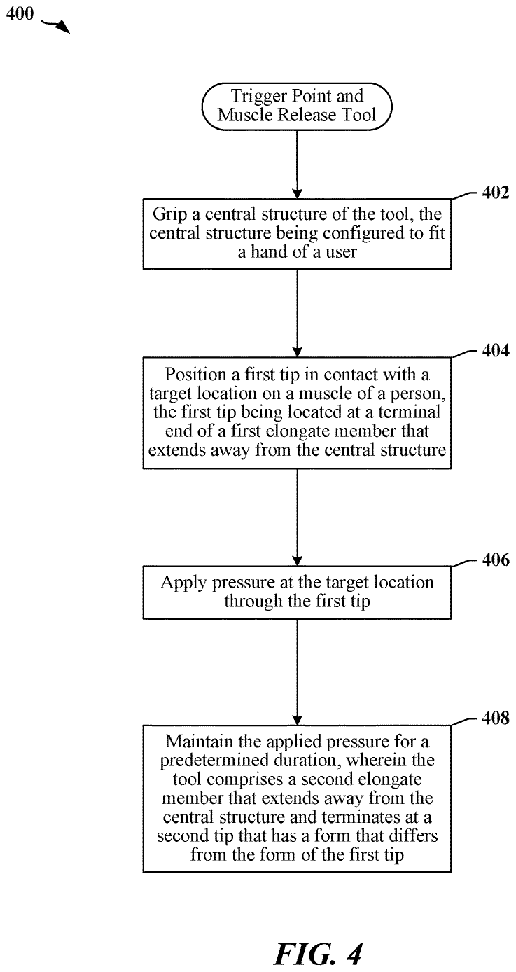

FIG. 4 is a flowchart 400 illustrating a method of using a trigger point and muscle release tool according to certain aspects of this disclosure. The tool may have a central structure configured to fit a hand of a user, a first elongate member extending away from the central structure and terminating at a first tip, and a second elongate member extending away from the central structure and terminating at a second tip. At block 402, the central structure of the tool may be gripped by a user. At block 404, a first tip may be positioned in contact with a target location on a muscle of a person. At block 406, pressure may be applied at the target location through the first tip. At block 408, the applied pressure may be maintained for a predetermined duration.

In one example, the first tip has a spoon-shaped form. The method may include positioning the person in a supine position with knees bent, placing the spoon-shaped first tip into the anterior hip area of the person at or near the iliopsoas muscle, and gripping the central structure with both hands and applying steady pressure through the first tip into the iliopsoas muscle. The pressure may be maintained for some duration of time that is typically longer than 10 seconds. In another example, the duration of time is greater than 30 seconds and no more than 60 seconds. In another example, the duration of time is greater than 60 seconds. The method may further include slowly extending a leg of the person and then returning the leg to a bent position while maintaining the pressure into the iliopsoas muscle. The steps of extending and returning may be repeated a number of times. In one example, the steps of extending and returning may be repeated three to five times or more.

In one example, the first tip has a knob-shaped form. The method may include locating a trigger point by moving the tool until a tender or tight spot is identified in a muscle at the target location, applying firm, steady pressure through the first tip at the trigger point, and maintaining the pressure for some duration of time that is typically longer than 10 seconds. In another example, the duration of time is greater than 30 seconds and no more than 60 seconds. In another example, the duration of time is greater than 60 seconds. Pressure may then be released and the method may be repeated at a subsequent trigger point.

In some implementations, the first tip has a substantially spherical surface. In some implementations, the first tip has a substantially hemispherical surface. In some implementations, the first tip has a substantially frustoconical surface.

In certain implementations, the first elongate member extends away from the central structure along a first line and the second elongate member extends away from the central structure along a second line. In one example, an obtuse angle is provided between the first line and the second line. In another example, an acute angle is provided between the first line and the second line.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

What is claimed is:

1. A tool for applying pressure to a muscle, comprising:
a central structure configured to fit a hand of a user;
a first elongate member extending away from the central structure and terminating at a first tip; and
a second elongate member extending away from the central structure and terminating at a second tip.

2. The tool of claim 1, wherein the first tip has a spherical surface.

3. The tool of claim 1, wherein the first tip includes a hemispherical structure.

4. The tool of claim 1, wherein the first tip has a frustoconical portion.

5. The tool of claim 1, wherein a surface of the first tip includes a portion of a polyhedron.

6. The tool of claim 1, wherein at least one tip has a flattened circular shape.

7. The tool of claim 1, wherein the tool comprises a spoon-shaped tip.

8. The tool of claim 7, wherein the spoon-shaped tip is configured to release a muscle group upon contact.

9. The tool of claim 7, wherein the spoon-shaped tip is configured to release an iliopsoas muscle group of a supine person.

10. The tool of claim 7, wherein the spoon-shaped tip is configured to release a psoas muscle of a supine person.

11. The tool of claim 1, wherein the first elongate member extends away from the central structure along a first line and the second elongate member extends away from the central structure along a second line and wherein an obtuse angle is provided between the first line and the second line.

12. The tool of claim 1, wherein the first elongate member extends away from the central structure along a first line and the second elongate member extends away from the central structure along a second line and wherein an acute angle is provided between the first line and the second line.

13. The tool of claim 1, wherein the central structure has a size and shape configured to be gripped with both hands of a user simultaneously.

14. The tool of claim 1, wherein the first tip is configured to locate and apply pressure to a trigger point on a muscle.

15. A method of using a trigger point and muscle release tool, comprising:
gripping a central structure of the tool, the central structure being configured to fit a hand of a user;
positioning a first tip in contact with a target location on a muscle of a person, the first tip being located at a terminal end of a first elongate member that extends away from the central structure;
applying pressure at the target location through the first tip; and
maintaining the applied pressure for a predetermined duration,
wherein the tool comprises a second elongate member that extends away from the central structure and terminates at a second tip that has a form that differs from the form of the first tip.

16. The method of claim 15, wherein the first tip has a spoon-shaped form, and wherein the method further comprises:
positioning the person in a supine position with knees bent;
placing the first tip into the anterior hip area of the person at or near the iliopsoas muscle;
gripping the central structure with both hands and applying steady pressure through the first tip into the iliopsoas muscle;
maintaining the pressure for 30 to 60 seconds;
slowly extending a leg of the person and then returning the leg to a bent position while maintaining the pressure into the iliopsoas muscle; and
repeating the extending and returning three to five times.

17. The method of claim 15, wherein the first tip has a knob-shaped form, and wherein the method further comprises:
locating a trigger point by moving the tool until a tender or tight spot is identified in a muscle at the target location;
applying firm, steady pressure through the first tip at the trigger point; and
maintaining the pressure for 30 to 60 seconds or until the muscle softens.

18. The method of claim 15, wherein the first tip has a substantially spherical surface.

19. The method of claim 15, wherein the first elongate member extends away from the central structure along a first line and the second elongate member extends away from the central structure along a second line, and wherein an obtuse angle is provided between the first line and the second line.

20. The method of claim 15, wherein the first elongate member extends away from the central structure along a first line and the second elongate member extends away from the central structure along a second line, and wherein an acute angle is provided between the first line and the second line.
